(19) United States
(12) Patent Application Publication
(10) Pub. No.: US 2017/0060892 A1
(43) Pub. Date: Mar. 2, 2017

(54) SEARCH-BASED SHAREABLE COLLECTIONS

(71) Applicant: Dropbox, Inc., San Francisco, CA (US)

(72) Inventor: Himabindu Vuppula, Santa Clara, CA (US)

(21) Appl. No.: 14/842,149

(22) Filed: Sep. 1, 2015

(51) Int. Cl. G06F 17/30

(52) U.S. Cl. CPC G06F 17/30106; G06F 17/30174

(57) ABSTRACT

An example method includes identifying one or more content items in a first user account according to a first search string. The example method can then include storing a pointer to each of the one or more content items in the first user account in a shared folder, the shared folder allowing the first user account or a second user account to access the one or more content items in the first user account. The example method can then include identifying one or more content items in the second user account according to a second search string. The method can then include storing a pointer to each of the one or more content items in the second user account in the shared folder, the shared folder allowing the first user account or the second user account to access the one or more content items in the second user account.

### BACKGROUND

Many online synchronized content management systems facilitate the sharing of content items amongst users. These users typically spend a large amount of time organizing their content items into collections according to individually preferred paradigms. Current approaches permit users to share content items individually or share entire collections. If a user wishes to share a large quantity of content items, sharing them individually can be time-intensive, difficult to manage, and inconvenient for the recipient. Sharing the entire collection, however, might result in sharing content items that the user wishes to keep private.

Current approaches for sharing content items clash with many users' organizational paradigms. In order to better facilitate sharing, a user might abandon their preferred organization and move content items into shared collections. Alternatively, the user might create a copy of the content item in a shared collection. This approach results in two copies of the same content item where the copy will not reflect changes made to the original and the original will not reflect changes made to the copy. Further, this requires a two-step process of copying a content item to a new collection and setting sharing permissions for the collection.

The foregoing limitations of available systems might dissuade a user from sharing their content items, force them to forgo their preferred organizational paradigm, or overwhelm them by the resulting entanglement of paradigms and priorities.

### SUMMARY

The description and disclosed principles that follow will set forth, render partly obvious, and teach through practice additional features and advantages of the disclosure. The instruments and combinations particularly pointed out in the appended claims can realize and obtain the features and advantages of the disclosure. These and other features of the disclosure will become more fully apparent from the following description and appended claims, or can be learned by the practice of the principles set forth herein.

Disclosed are systems, methods, and non-transitory computer-readable storage media for creating a smart collection (e.g., a shared folder or a read-only folder that is accessible to a user or multiple users). An example computer-implemented method to create such a shared folder includes identifying one or more content items in a first user account according to a first search string, the first user account being in an online synchronized content management system. The computer can then store a pointer to each of the one or more content items in the first user account in a shared folder, the shared folder allowing the first user account or a second user account to access the one or more content items in the first user account.

In some embodiments, the computer can then identify one or more content items in the second user account according to a second search string, the second user account being in the online synchronized content management system. The computer can then store a pointer to each of the one or more content items in the second user account in the shared folder, the shared folder allowing the first user account or the second user account to access the one or more content items in the second user account.

In some embodiments, the shared folder is a shared folder stored in the first user account.

Another example computer-implemented method to create a smart collection based on a read-only folder includes identifying one or more content items in a user account according to a search string, the user account being in an online synchronized content management system. In some embodiments, the computer can store a pointer to each of the one or more content items in the user account in the read-only folder. The pointer can specify a content storage location. In some embodiments, the pointer can be a copy of each of the one or more content items in the user account that are stored in the read-only folder.

In some embodiments, the computer can receive a modification to a content item accessible through the smart collection, and provide access to the modification through the smart collection. The modification can be made to the original content item. In the case where the computer stores a copy of the content item in the smart collection, the computer can copy the modified content item to the smart collection to update the content item in the smart collection.

In some embodiments, the read-only based smart collection can be a read-only shared folder allowing a first user account or second user account to access the one or more content items in the smart collection. In some cases, content items accessible through the smart collection can be limited to content items in the first user account. Alternatively, the computer can identify one or more content items in the second user account according to a second search string, the second user account being in the online synchronized content management system. The computer can then store a pointer to each of the one or more content items in the second user account in the shared folder, the shared folder allowing the first user account or the second user account to access the one or more content items in the second user account.

In some embodiments, a smart collection can be created once through an initial search. Alternatively, the smart collection can be updated using the original search or a modified search, such as at periodic intervals or manually through user action. In the case of a smart collection based on a read-only folder, the read-only permissions can be configured to allow additional content items to be added to or removed from the smart collection, but to prevent a user from directly modifying the content of a content item stored in the smart collection.

### BRIEF DESCRIPTION OF THE DRAWINGS

The above-recited and other advantages and features of the disclosure will become apparent by reference to specific embodiments thereof which are illustrated in the appended drawings. Understanding that these drawings depict only example embodiments of the disclosure and are not therefore to be considered to be limiting of its scope, the disclosure describes and explains the principles herein with additional specificity and detail through the use of the accompanying drawings in which:

FIG. 1 shows an example configuration of devices and a network in accordance with the invention;

FIG. 2 shows an example collection hierarchy in accordance with the present technology;

FIG. 3 shows an example table of smart collections their corresponding selection query and corresponding access list;

FIG. 4 shows an example smart collection creation graphical user interface;

FIG. 5 shows an example smart collection's contents where the smart collection has multiple contributors;

FIGS. 6A and 6B show example nested smart collections;

FIG. 7 shows various items that a smart collection can include;

FIG. 8 shows an example method for creating a smart collection with content from two users;

FIG. 9A shows an example possible system embodiment for implementing various embodiments of the present technology; and

FIG. 9B shows an example possible system embodiment for implementing various embodiments of the present technology.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for a shareable smart collection.

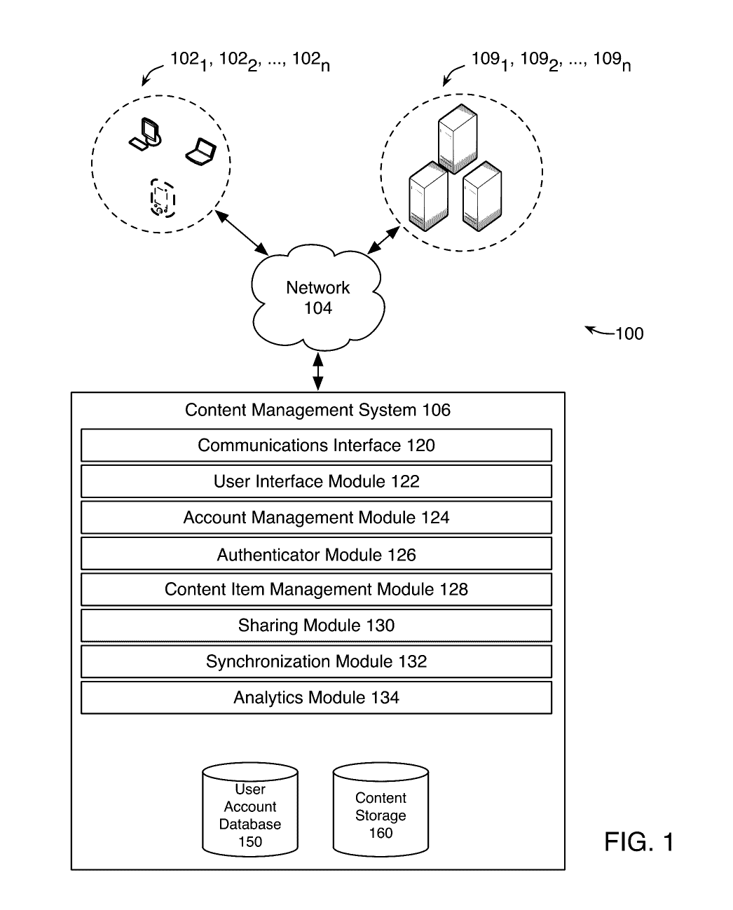

With respect to implementing various embodiments of the disclosed technology, an example system configuration 100 is shown in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, a user can interact with content management system 106 through client devices 102₁, 102₂, . . . , 102ₙ (collectively “102”) connected to network 104 by direct and/or indirect communication. Content management system 106 can support connections from a variety of different client devices, such as: desktop computers; mobile computers; mobile communications devices, e.g. mobile phones, smart phones, tablets; smart televisions; set-top boxes; and/or any other network enabled computing devices. Client devices 102 can be of varying type, capabilities, operating systems, etc. Furthermore, content management system 106 can concurrently accept connections from and interact with multiple client devices 102.

A user can interact with content management system 106 via a client-side application installed on client device 102ᵢ. In some embodiments, the client-side application can include a content management system specific component. For example, the component can be a stand-alone application, one or more application plug-ins, and/or a browser extension. However, the user can also interact with content management system 106 via a third-party application, such as a web browser, that resides on client device 102ᵢ and is configured to communicate with content management system 106. In either case, the client-side application can present a user interface (UI) for the user to interact with content management system 106. For example, the user can interact with the content management system 106 via a client-side application integrated with the file system or via a webpage displayed using a web browser application.

Content management system 106 can enable a user to store content, as well as perform a variety of content management tasks, such as retrieve, modify, browse, and/or share the content. Furthermore, content management system 106 can enable a user to access content from multiple client devices 102. For example, client device 102ᵢ can upload content to content management system 106 via network 104. Later, the same client device 102ᵢ or some other client device 102ⱼ can retrieve the content from content management system 106.

To facilitate the various content management services, a user can create an account with content management system 106. User account database 150 can maintain the account information. User account database 150 can store profile information for registered users. In some cases, the only personal information in the user profile can be a username and/or email address. However, content management system 106 can also be configured to accept additional user information such as birthday, address, billing information, etc.

User account database 150 can include account management information, such as account type (e.g. free or paid), usage information, (e.g. file edit history), maximum storage space authorized, storage space used, content storage locations, security settings, personal configuration settings, content sharing data, etc. Account management module 124 can be configured to update and/or obtain user account details in user account database 150. The account management module 124 can be configured to interact with any number of other modules in content management system 106.

Content management system can use an account to store content, such as digital data, documents, text files, audio files, video files, etc., from one or more client devices 102 authorized on the account. The content can also include collections for grouping content items together with different behaviors, such as folders, playlists, albums, etc. For example, an account can include a public folder that is accessible to any user. The public folder can be assigned a web-accessible address. A link to the web-accessible address can be used to access the contents of the public folder. In another example, an account can include: a photos collection that is intended for photos and that provides specific attributes and actions tailored for photos; an audio collection that provides the ability to play back audio files and perform other audio related actions; or other special purpose collection. An account can also include shared collections or group collections that are linked with and available to multiple user accounts. The permissions for multiple users may be different for a shared collection.

The content can be stored in content storage 160. Content storage 160 can be a storage device, multiple storage devices, or a server. Alternatively, content storage 160 can be a cloud storage provider or network storage accessible via one or more communications networks. Content management system 106 can hide the complexity and details from client devices 102 so that client devices 102 do not need to know exactly where or how the content items are being stored by content management system 106. In some embodiments, content management system 106 can store the content items in the same collection hierarchy as they appear on client device 102ᵢ. However, content management system 106 can store the content items in its own order, arrangement, or hierarchy. Content management system 106 can store the content items in a network accessible storage (NAS) device, in a redundant array of independent disks (RAID), etc. Content storage 160 can store content items using one or more partition types, such as FAT, FAT32, NTFS, EXT2, EXT3, EXT4, ReiserFS, BTRFS, and so forth.

Content storage 160 can also store metadata describing content items, content item types, and the relationship of content items to various accounts, collections, or groups. The metadata for a content item can be stored as part of the content item or can be stored separately. In some embodiments, content management system can assign a system-wide unique identifier to each content item stored in content storage 160.

Content storage 160 can decrease the amount of storage space required by identifying duplicate content items or duplicate segments of content items. Instead of storing multiple copies, content storage 160 can store a single copy and then use a pointer or other mechanism to link the duplicates to the single copy. Similarly, content storage 160 can store content items more efficiently, as well as provide the ability to undo operations, by using a content item version control that tracks changes to content items, different versions of content items (including diverging version trees), and a change history. The change history can include a set of changes that, when applied to the original content item version, produce the changed content item version.

Content management system 106 can be configured to support automatic synchronization of content from one or more client devices 102. The synchronization can be platform agnostic. That is, content management system can synchronize the content across multiple client devices 102 of varying type, capabilities, operating systems, etc. For example, client device 102ᵢ can include client software, which synchronizes, via a synchronization module 132 at content management system 106, content in client device 102ᵢ 's file system with the content in an associated user account. In some cases, the client software can synchronize any changes to content in a designated collection and its sub-collections, such as new, deleted, modified, copied, or moved content items or collections. The client software can be a separate software application, can integrate with an existing content management application in the operating system, or some combination thereof. In one example of client software that integrates with an existing content management application, a user can manipulate content items directly in a local collection, while a background process monitors the local collection for changes and synchronizes those changes to content management system 106. Conversely, the background process can identify content that has been updated at content management system 106 and synchronize those changes to the local collection. The client software can provide notifications of synchronization operations, and can provide indications of content statuses directly within the content management application. Sometimes client device 102ᵢ may not have a network connection available. In this scenario, the client software can monitor the linked collection for content item changes and queue those changes for later synchronization to content management system 106 when a network connection is available. Similarly, a user can manually start, stop, pause, or resume synchronization with content management system 106.

A user can view or manipulate content via a web interface generated and served by user interface module 122. For example, the user can navigate in a web browser to a web address provided by content management system 106. Content management system can propagate changes or updates to content in the content storage 160 made through the web interface, such as uploading a new version of a content item, back to other client devices 102 associated with the user's account. For example, multiple client devices 102, each with their own client software, can be associated with a single account and content items in the account can be synchronized between each of the multiple client devices 102.

Content management system 106 can include a communications interface 120 for interfacing with various client devices 102, and can interact with other content and/or service providers 109₁, 109₂, . . . , 109ₙ (collectively “109”) via an Application Program Interface (API). Certain software applications can access content storage 160 via an API on behalf of a user. For example, a software package, such as an app running on a smartphone or tablet computing device, can programmatically make calls directly to content management system 106, when a user provides credentials, to read, write, create, delete, share, or otherwise manipulate content. Similarly, the API can allow users to access all or part of content storage 160 through a web site.

Content management system 106 can also include authenticator module 126, which can verify user credentials, security tokens, API calls, specific client devices, and so forth, to ensure only authorized clients and users can access content items. Further, content management system 106 can include analytics module 134 module that can track and report on aggregate file operations, user actions, network usage, total storage space used, as well as other technology, usage, or business metrics. A privacy and/or security policy can prevent unauthorized access to user data stored with content management system 106.

Content management system 106 can include sharing module 130 for managing sharing content publicly or privately. Sharing content publicly can include making the content item accessible from any computing device in network communication with content management system 106. Sharing content privately can include linking a content item in content storage 160 with two or more user accounts so that each user account has access to the content item. Content management system can enable sharing in a platform agnostic manner. That is, the content can be shared across multiple client devices 102 of varying type, capabilities, operating systems, etc. The content can also be shared across varying types of user accounts.

In some embodiments, content management system 106 can be configured to maintain a content directory identifying the location of each content item in content storage 160. The content directory can include a unique content entry for each content item stored in the content storage.

A content entry can include a content path that can identify the location of the content item in a content management system. For example, the content path can include the name of the content item and a folder hierarchy associated with the content item. For example, the content path can include a folder or path of folders in which the content item is placed as well as the name of the content item. Content management system 106 can use the content path to present the content items in the appropriate folder hierarchy.

A content entry can also include a content pointer that identifies the location of the content item in content storage 160. For example, the content pointer can include the exact storage address of the content item in memory, e.g., a file path. In some embodiments, the content pointer can point to multiple locations, each of which contains a portion of the content item.

In addition to a content path and content pointer, a content entry can also include a user account identifier that identifies the user account that has access to the content item. In some embodiments, multiple user account identifiers can be associated with a single content entry indicating that the content item has shared access by the multiple user accounts.

To share a content item privately, sharing module 130 can be configured to add a user account identifier to the content entry associated with the content item, thus granting the added user account access to the content item. Sharing module 130 can also be configured to remove user account identifiers from a content entry to restrict a user account's access to the content item.

To share content publicly, sharing module 130 can be configured to generate a custom network address, such as a uniform resource locator (URL), which allows any web browser to access the content in content management system 106 without any authentication. To accomplish this, sharing module 130 can be configured to include content identification data in the generated URL, which can later be used to properly identify and return the requested content item. For example, sharing module 130 can be configured to include the user account identifier and the content path in the generated URL. Upon selection of the URL, the content identification data included in the URL can be transmitted to content management system 106 which can use the received content identification data to identify the appropriate content entry and return the content item associated with the content entry.

In addition to generating the URL, sharing module 130 can also be configured to record that a URL to the content item has been created. In some embodiments, the content entry associated with a content item can include a URL flag indicating whether a URL to the content item has been created. For example, the URL flag can be a Boolean value initially set to 0 or false to indicate that a URL to the content item has not been created. Sharing module 130 can be configured to change the value of the flag to 1 or true after generating a URL to the content item.

In some embodiments, sharing module 130 can also be configured to deactivate a generated URL. For example, each content entry can also include a URL active flag indicating whether the content should be returned in response to a request from the generated URL. For example, sharing module 130 can be configured to only return a content item requested by a generated link if the URL active flag is set to 1 or true. Thus, access to a content item for which a URL has been generated can be easily restricted by changing the value of the URL active flag. This allows a user to restrict access to the shared content item without having to move the content item or delete the generated URL. Likewise, sharing module 130 can reactivate the URL by again changing the value of the URL active flag to 1 or true. A user can thus easily restore access to the content item without the need to generate a new URL.

While FIG. 1 presents content management system 106 with specific components, it should be understood by one skilled in the art, that the architectural configuration of system 106 is simply one possible configuration and that other configurations with more or fewer components are possible.

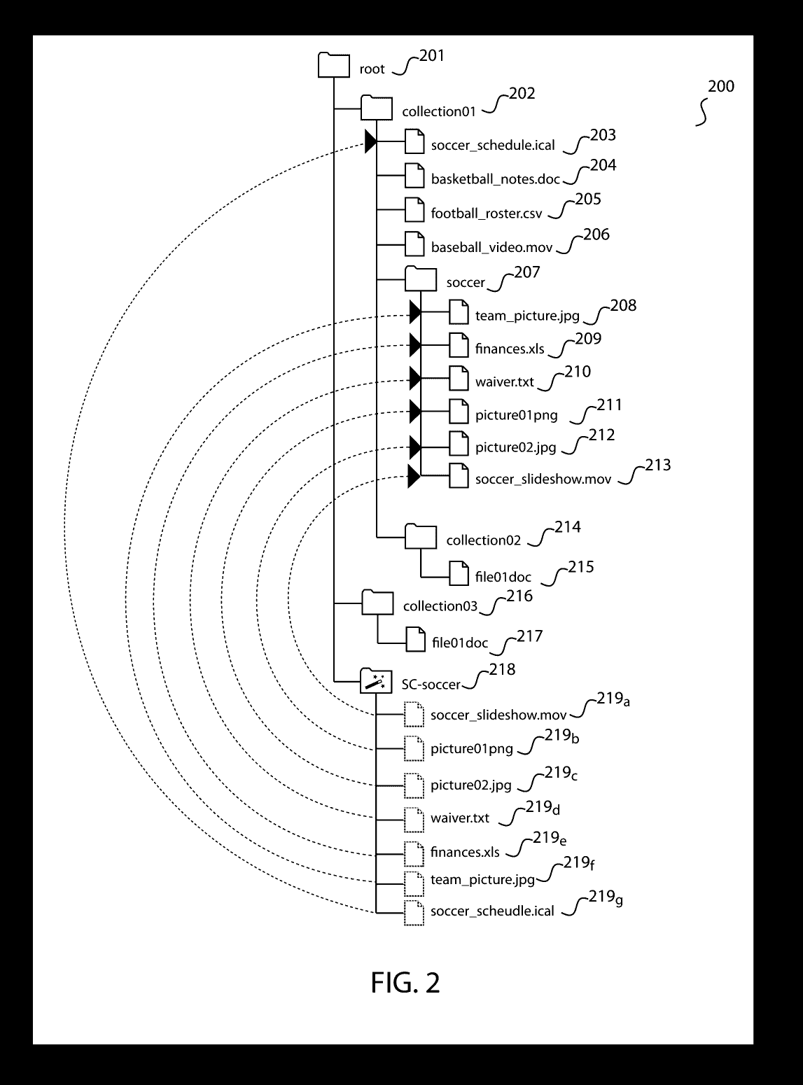

FIG. 2 shows an example collection hierarchy 200 in accordance with some embodiments. Collections 201, 202, 207, 214, 216, and 218 (“root,” “collection01,” “soccer,” “collection02,” “collection03,” and “SC-soccer”) can contain items such as files, collections, pointers to files stored in other collections, collection metadata, etc. For example, collection 202 (“collection01”) contains files 203-206 (“soccer_schedule.ical,” “basketball_notes.doc,” “football_roster.csv,” and “baseball_video.mov”) and collections 207 and 214 (“soccer” and “collection02”).

Smart collection 218 (“SC-soccer”) can contain pointers 219ₐ-219_{g} (collectively, pointers 219) corresponding to various files in collection hierarchy 200. For example, pointer 219ₐ corresponds to file 213 (“soccer_slideshow.mov”). The dashed arrows in FIG. 2 indicate pointers 219's corresponding items.

Smart collection 218 can be a collection of items, such as pointers, files, folders, collections, content items, etc. Various techniques can create smart collection 218, as described elsewhere in this specification. In FIG. 2, a search string of “soccer” created smart collection 218 (“SC-soccer”). This string matched file 203 (“soccer_schedule.ical”) as well as files 208-213 contained within folder 207 (“soccer”). In some embodiments, pointers 219 can be placed at the root of a smart collection 218 (as depicted) or retain their original collection structure. For example, smart collection 218 can include a sub-collection with filename “collection01” (corresponding to collection 202) which, can itself, contain pointer 209_{g} and another sub-collection with filename “soccer” (corresponding to folder 207) including pointers 209ₐ-209_{f}.

Although the disclosure uses the term “smart collection,” it should be understood that smart collections do not require any advanced algorithms, dynamic computation, automatic operation, or artificial intelligence to practice the principles herein disclosed. A static, one-time, search can create a smart collection. Alternatively, a smart collection can: continuously search for matching items; use machine learning and analytics to determine what items likely should be included in the smart collection (e.g., a user can identify a representative sampling of items and the smart collection can determine common characteristics and identify items with those characterized); dynamically change according to predetermined criteria (e.g., the smart collection could match the most recent 20 items); or a combination of the foregoing.

In some embodiments, content management system places items that match the search at the root of smart collection 218. For example, pointer 219ₐ, 219_{g}, and a pointer corresponding to folder 207 can all reside in smart collection 218's root. It should be understood that content management system can place an identical pointer in multiple places within a smart collection. For example, content management system can place pointer 219ₐ at smart collection 218's root because it matches the search individually, it can also place pointer 219ₐ within a pointer to folder 207 because folder 207 matches the search.

A pointer can be the path to the original item, an address of the location of the original item, a hyperlink to the original item, shortcut, a unique identifier of the original item, a link, a symbolic link, an alias, or an actively synchronized copy of the original item. If the pointer is an actively synchronized copy of the original item, content management system can replicate any changes to either the copy or the original to the corresponding original or copy.

In some embodiments, content management system presents a user with an interface that is similar to the underlying actual file structure on the online synchronized content management system. Alternatively, content management system can present the user with an interface that hides the internal file structure of the computing system. For example, the interface can present content items in multiple places as if they were different copies, even though the actual file structure only has one copy of the item while the rest are pointers to that content item.

In some embodiments, a graphical user interface (GUI) element can indicate that a collection is a smart collection. Alternatively, an interface can omit such indication and present the collection as if it were a standard collection. Similarly, a GUI element can indicate that a pointer within the smart collection is a pointer and not the original item. For example, the icon for the content item can be semi-transparent or made of dashed lines (as depicted). Alternatively, such an indication is not necessary and the pointer can appear as though it were the original content item.

In some embodiments, a search might match a folder (such as folder 207). In some such embodiments, pointers 219 point to folders. A GUI element can then indicate that they point to folders (e.g., by representing the pointer as a folder icon). Smart collection 218 can represent a matched folder and its contents in various ways. For example, smart collection 218 can contain a pointer corresponding to matched folder 207, which would then include pointers 219ₐ-219_{f}. In some embodiments, smart collection 218 can contain a pointer corresponding to matched folder 207 and, when something accesses the pointer, the pointer can take the accessor to folder 207's original location, which includes original files 208-213. Alternatively, smart collection 218 can include pointers 219ₐ-219_{f} as if they were each matched individually (as depicted in FIG. 2), even though some pointers, such as 219_{b}-209_{f}, might not individually match the search. A combination of the foregoing is also possible.

In some embodiments, a smart collection can match only one content item. For example, smart collection can match a most recent email or file. In some such embodiments, the smart collection can behave as though it were the individual content item or pointer to the content item. For example, a user would not need to open the collection to view the pointer; the user could simply access the pointer directly.

In some embodiments, the data and collection hierarchy herein disclosed can be located on an online synchronized content management system. In some embodiments, one user of the online synchronized content management system owns items (files, collections, smart collections, etc.) and shares them to another user of the system. Alternatively, a user can share the items to anyone via an internet link.

An online synchronized content management system can perform the various tasks herein disclosed such as searching for items, storing items, moving items, copying items, performing analytics and machine learning, receiving user input, adjusting security policies, maintaining sharing policies between users, etc. In some embodiments, different systems or machines can perform the foregoing tasks.

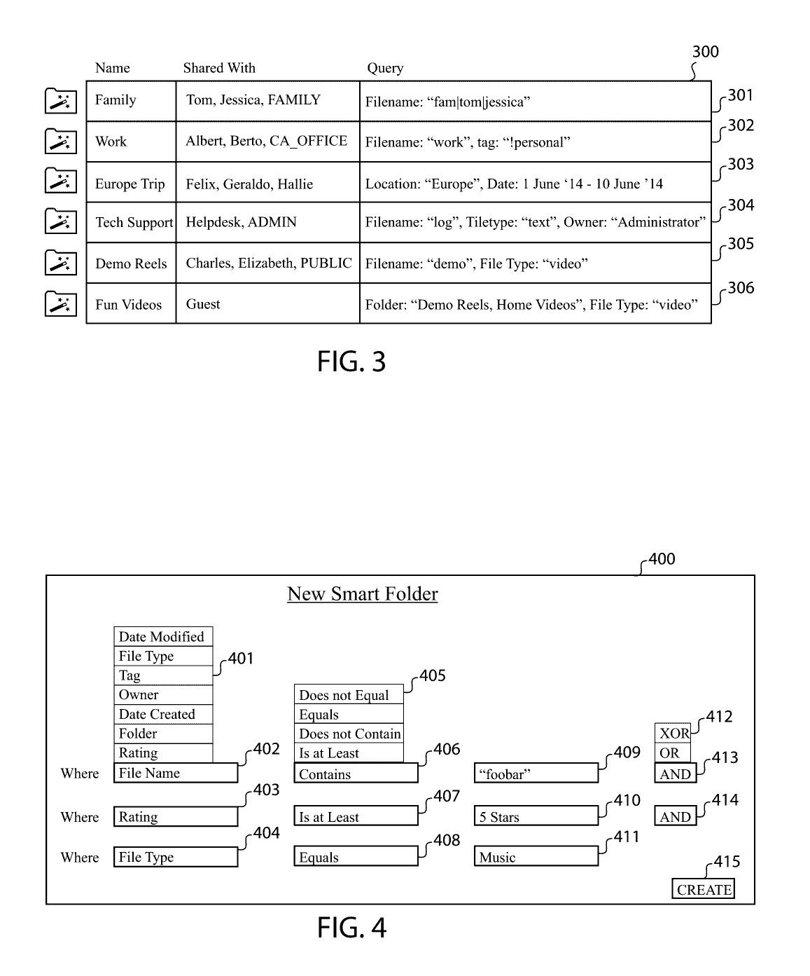

FIG. 3 represents various example smart collections and their accompanying name, sharing permissions, and the search queries that created them. Various searching and query languages, formats, and styles can be utilized determine which files should be matched for a smart collection. For example, a search query can use SQL, MYSQL, NOSQL, regular expressions, pattern matching, natural language, etc.

As depicted in FIG. 3, a smart collection can be shared with individual users (e.g., “Tom” and “Jessica” of smart collection 301 and “Albert” and “Berto” of smart collection 302), groups of users (e.g., smart collection 301 is shared with “FAMILY”), classes of users (e.g., smart collection 304 is shared with the “ADMIN” class, including network administrators), or be universally accessible to all users (e.g., smart collection 305 is shared with the public). It should be understood that smart collections can be shared with users, collections of users, and classes according to various privacy and security policies.

A smart collection can match items based on a combination of searches. For example, smart collection 303 matches items with a location of “Europe” that have dates between “1 Jun. '14” and “10 Jun. '14”.

FIG. 4 is an example graphical user interface 400 that depicts the creation of an example search. Fields 402, 403, and 404 can receive a selection of field options 401. Conditions 406, 407, and 48 can receive a selection of condition options 405. A user can fill out values 409, 410, and 411. Search logic 413 and 414 can receive a selection of search logic options 412. A user can customize the fields, conditions, values, and search logic options to create a search for a smart collection. As depicted in FIG. 4, the example graphical user interface 400 would search for any item where the filename contains “foobar,” the rating is at least 5 stars, and the content item type is “Music.” As mentioned elsewhere in this disclosure, alternative search methods and techniques (e.g., natural language) are also effective to create a smart collection.

Field options 401 can include date modified, content item type, tag (e.g., user assigned annotation), owner, date created, (parent) collection, rating, content item size, shared with, duration (for media recordings), subject matter, author, location, price, upload date, content item history, creator, editors, etc. Condition options 405 can include “does not equal,” “equals,” “does not contain,” “is at least,” “contains,” “is similar to,” “is less than,” “is associated with,” etc. Values 409, 410, and 411 can include any user input. In some embodiments, values 409-411 accept regular expressions or similar (e.g., “f??b*” could match terms that have an “f,” two characters, and a “b” followed by any string of characters). Combining field 402 with condition 406 and value 409 results in a basic search (in this example, any item where the filename contains “foobar”). Search logic 413 and 414 can combine basic searches and can include various logical functions such as “logical and” (AND), “logical or” (OR), “logical exclusive or” (XOR), “logical not and” (NAND), “logical not” (NOT), etc.

In some embodiments, a search can include fields and/or values contained in metadata associated with a content item. The metadata can describe the history (e.g., file history) of a content item. In some such embodiments, the history of the content item can include the users that authored, edited, saved, own, or have access privileges to the content item, the history of the content item can also include various metadata pertaining to prior versions of the content item. The search can also include other fields and/or values contained in metadata relevant to a content item such as creation location, name, content item storage location, type, artist (for media), playlist, play count, domain, network, tags, keywords, compression standard, extension, encryption type, geographical location (e.g., where the content item was created or is currently stored), access privileges (e.g., read only, read-write, etc.), expiration date (e.g., for media rentals), a cost associated with the content item, or any other descriptor of the content item.

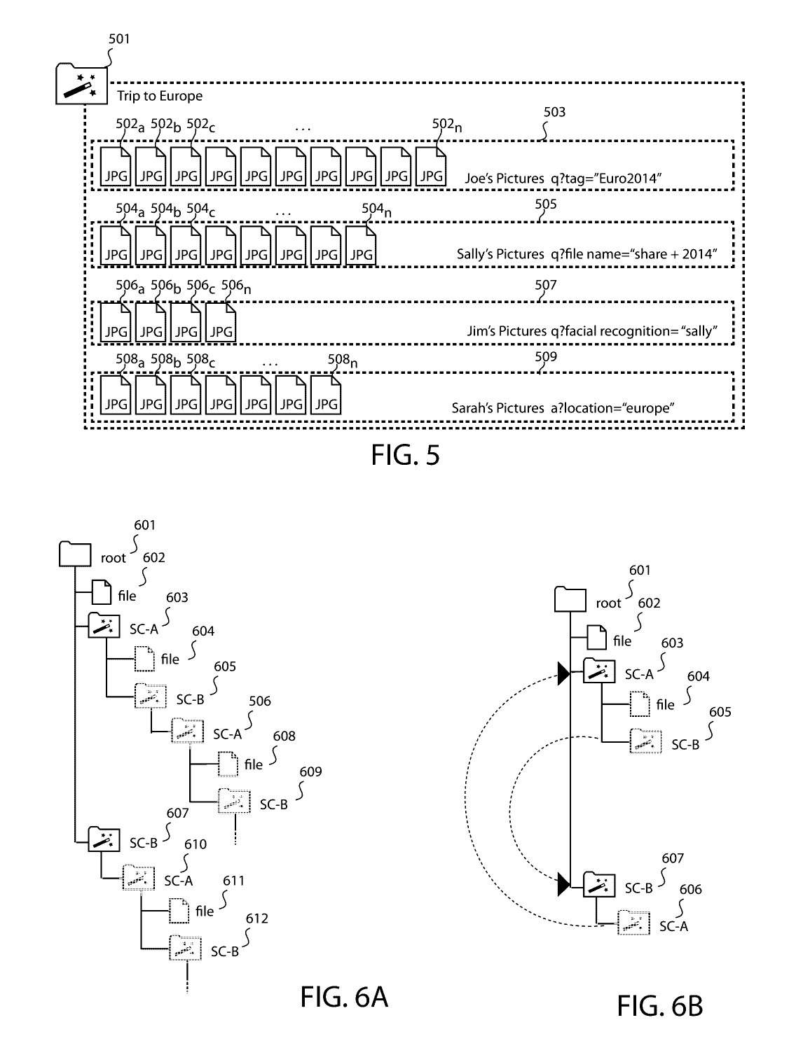

FIG. 5 represents an example embodiment wherein smart collection 501 (“Trip to Europe”) includes a collection of items coming from various users (Joe, Sally, Jim, and Sarah). Smart collection 501 can contain items coming from multiple accounts, hierarchies, services, users, clouds, time periods, etc. In some embodiments, multiple users can supply different search criteria to submit content items for smart collection 501. This can be beneficial, as users tend to organize their data using different techniques, relying on tags, hierarchy, location, dates, etc. For example, as depicted in FIG. 5: Joe submitted a search query of all items that contain a tag of “Euro2014” which matched content items 502ₐ-502ₙ (collectively, 502); Sally's query is “share+2014” resulting in content items 504ₐ-504ₙ (collectively, 504); Jim's query is any picture where the computer recognized (using facial recognition) that “Sally” was in the picture which matched content items 506ₐ-506ₙ (collectively 506); and Sarah submitted a query for all items with a location of “Europe” which matched content items 508ₐ₋ₙ (collectively, 508). Smart collection 501 can represent all content items 502, 504, 506, and 58 distinctly and indicate which content items come from which users. Alternatively, smart collection 501 can represent all content items in a combined form and hide their source from a user.

In some embodiments, the original creator of smart collection 501 retains sole ownership of smart collection 501. For example, only the creator/owner can share smart collection 501 to others. Alternatively, all contributors can have ownership privileges. In some embodiments, each contributor has ownership of their own contribution.

In some embodiments, a user manually creates the smart collections; alternatively, content management system can automatically generate smart collections. For example, if the content management system detects that multiple users were involved with the same activity, then the content management system can automatically create a smart collection for the activity and populate the smart collection with pointers corresponding to content items in each user's collection that the system determines were related to the activity. In some embodiments, content management system can automatically create smart collections for events, activities, organizations, topics, etc. In some embodiments, a system scans media items and detects users that are present in the items (e.g., using facial recognition in a picture or determining that a text document was about a user); the system can then create a smart collection for each detected user and share the collection with the detected user. For example, if John takes a picture of Sally and uploads the picture to his data collection, a computer can detect that Sally is in the picture, create a smart collection with a pointer to the picture, and share the smart collection with Sally. In some embodiments, an automatically created smart collection requires the owner's permission to share its contents.

In some embodiments, a user can populate a smart collection using a drag and drop interface. In some embodiments, a user can select multiple content items and populate a smart collection with those content items in one action. Such actions could create pointers in the smart collection wherein the pointers point to the original content items. In some embodiments, content management system prompts a user whether they wish to move the actual content items or create a pointer. In some embodiments, implementations of various techniques can populate a smart collection. For example, a system can automatically create a smart collection, a user can create an additional search term, and a user can drag and drop individual items into the smart collection.

The above techniques can similarly remove or exclude content items from a smart collection. For example, a user could create a smart collection using a search and then manually select content items to exclude from the smart collection. This can be useful when the user wishes to share a large quantity of content items but exclude a select few. For example, a user may want to share all pictures from a recent vacation but exclude a few undesirable pictures.

FIGS. 6A and 6B depict nested smart collections. An account can contain multiple smart collections 603 and 607. A smart collection can contain another smart collection or a pointer to a smart collection. As depicted in FIG. 6A, nested smart collections can be partially or fully recursive. For example, a first smart collection 603 may contain a second smart collection 605 which itself contains the first smart collection 606 (which, in turn contains the second smart collection 609, ad infinitum). Thus, the path “root/SC-A/SC-B/SC-A/file” can represent the location of pointer 608.

FIG. 6B depicts an alternative representation of the same collection hierarchy in FIG. 6A, but without the infinite recursion outcome. Smart collection pointer 605 (“SC-B”) can redirect to its corresponding smart collection 607 and smart collection pointer 606 (“SC-A”) can redirect to smart collection 603. Thus configured, if a user (or computer program) accesses the contents of root 601, then smart collection 603, then smart collection pointer 605, they will be redirected to smart collection 607. If the user (or computer program) were to then access smart collection pointer 606, they will be redirected to smart collection 603 and presented with file 604 and smart collection pointer 605; the path of file 604 would then be “root/SC-A/file” and not “root/SC-A/SC-B/SC-A/file” as in other embodiments.

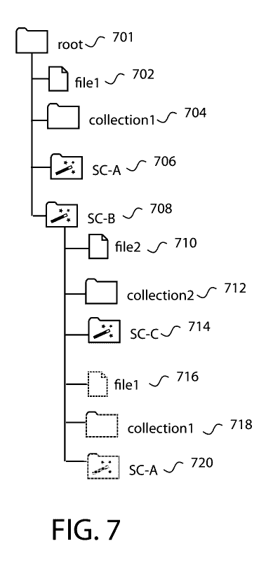

FIG. 7 depicts various types of items that can exist within a smart collection, highlighting that a “hybrid” smart collection can include pointers as well as other items. For example, smart collection 708 (“SC-B”) can contain file 710 (“file2”), collection 712 (“collection2”), and smart collection 714 (“SC-C”) which are not pointers; these items are located (i.e. “stored”) within the smart collection and do not need to correspond to any other content item, collection, or smart collection in the system. Alongside the aforementioned items, smart collection 708 can include file pointer 716 (“file1” corresponding to file 702), collection pointer 718 (“collection1” corresponding to collection 704), and smart collection pointer 720 (“SC-A” corresponding to smart collection 706).

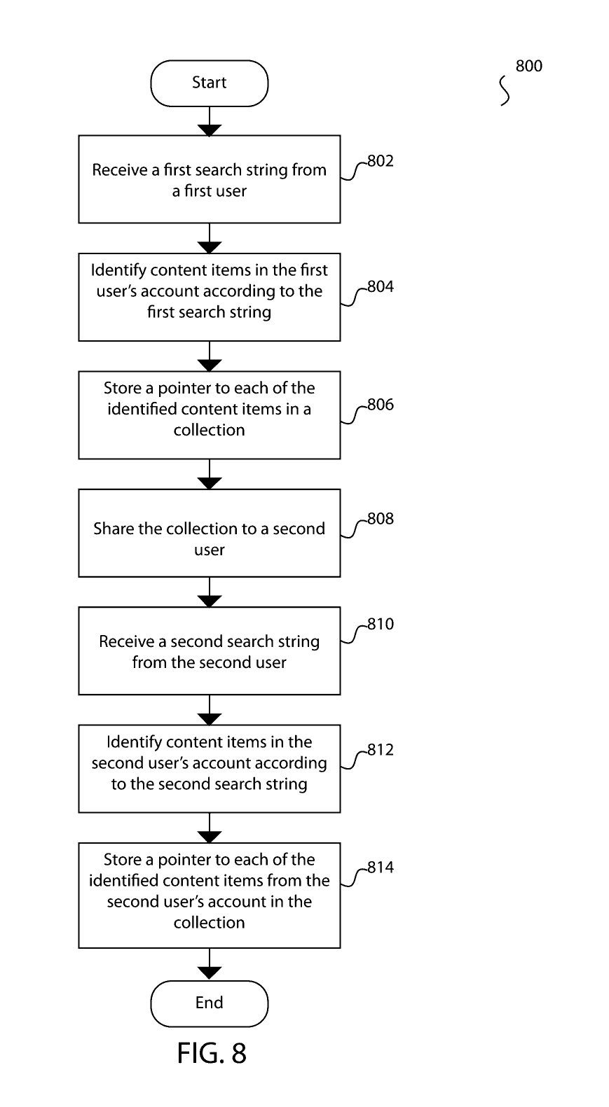

FIG. 8 shows an example method 800 embodying elements of the present disclosure. A system can receive a first search string from a first user (802). The system can then identify content items in the first user's account according to the first search string (804). The system can then store a pointer to each of the identified content items in a collection (806). The system can then share the collection to a second user (808). The system can then receive a second search string from the second user (810). The system can then identify content items in the second user's account according to the second search string (812). The system can then store a pointer to each of the identified content items from the second user's account in the collection (814). It should be understood that some embodiments rearrange or omit some steps of method 800.

The example method of FIG. 8 can further include an aspect where the collection is a folder. The collection can also be other types of collections, e.g., a playlist, photo album, etc. The collection can be hierarchical, be relational, or adhere to other data structure paradigms.

The example method of FIG. 8 can further include an aspect where identifying content items in the first user's account includes identifying metadata of the content items in the first user account that correspond with the first search string. Similarly, the identifying content items in the second user's account can further include identifying metadata of the content items in the second user account that correspond with the second search string. In some embodiments, the content management system can automatically generate the search strings. For example, the content management system can detect that various users were at the same event and create a search string that will capture content items from the event.

The example method of FIG. 8 can further include an aspect in which the content management system facilitates a user being able to edit the content item within the collection. For example, the first user or the second user may make changes to a text file that is in the collection. Content management system can reflect these changes in the file that is stored in the original location, which is accessible via the pointer in the collection.

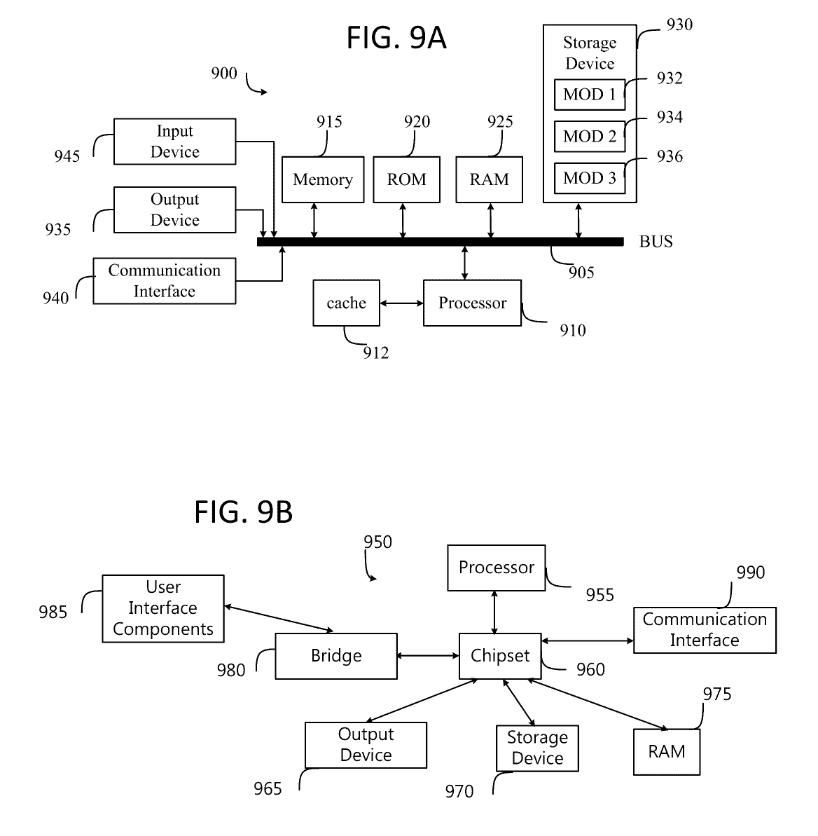

9A and FIG. 9B show example possible system embodiments. The more appropriate embodiment will be apparent to those of ordinary skill in the art when practicing the present technology. Persons of ordinary skill in the art will also readily appreciate that other system embodiments are possible.

FIG. 9A illustrates a conventional system bus computing system architecture 900 wherein the components of the system are in electrical communication with each other using a bus 905. Example system 900 includes a processing unit (CPU or processor) 910 and a system bus 905 that couples various system components including the system memory 915, such as read only memory (ROM) 920 and random access memory (RAM) 925, to the processor 910. The system 900 can include a cache of high-speed memory connected directly with, in close proximity to, or integrated as part of the processor 910. The system 900 can copy data from the memory 915 and/or the storage device 930 to the cache 912 for quick access by the processor 910. In this way, the cache can provide a performance boost that avoids processor 910 delays while waiting for data. These and other modules can control or be configured to control the processor 910 to perform various actions. Other system memory 915 may be available for use as well. The memory 915 can include multiple different types of memory with different performance characteristics. The processor 910 can include any general purpose processor and a hardware module or software module, such as module 1 932, module 2 934, and module 3 936 stored in storage device 930, configured to control the processor 910 as well as a special-purpose processor where software instructions are incorporated into the actual processor design. The processor 910 may essentially be a completely self-contained computing system, containing multiple cores or processors, a bus, memory controller, cache, etc. A multi-core processor may be symmetric or asymmetric.

To enable user interaction with the computing device 900, an input device 945 can represent any number of input mechanisms, such as a microphone for speech, a touch-sensitive screen for gesture or graphical input, keyboard, mouse, motion input, speech and so forth. An output device 935 can also be one or more of a number of output mechanisms known to those of skill in the art. In some instances, multimodal systems can enable a user to provide multiple types of input to communicate with the computing device 900. The communications interface 940 can generally govern and manage the user input and system output. There is no restriction on operating on any particular hardware arrangement and therefore improved hardware or firmware arrangements may easily take the place of the basic features here as the improved hardware or firmware arrangements are developed.

Storage device 930 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 925, read only memory (ROM) 920, and hybrids thereof.

The storage device 930 can include software modules 932, 934, 936 for controlling the processor 910. Other hardware or software modules are contemplated. The storage device 930 can connect to the system bus 905. In one aspect, a hardware module that performs a particular function can include the software component stored in a computer-readable medium in connection with the necessary hardware components, such as the processor 910, bus 905, display 935, and so forth, to carry out the function.

FIG. 9B illustrates a computer system 950 having a chipset architecture that can be used in executing the described method and generating and displaying a graphical user interface (GUI). Computer system 950 is an example of computer hardware, software, and firmware that can be used to implement the disclosed technology. System 950 can include a processor 955, representative of any number of physically and/or logically distinct resources capable of executing software, firmware, and hardware configured to perform identified computations. Processor 955 can communicate with a chipset 960 that can control input to and output from processor 955. In this example, chipset 960 outputs information to output 965, such as a display, and can read and write information to storage device 970, which can include magnetic media, and solid state media, for example. Chipset 960 can also read data from and write data to RAM 975. A bridge 980 for interfacing with a variety of user interface components 985 can be provided for interfacing with chipset 960. Such user interface components 985 can include a keyboard, a microphone, touch detection and processing circuitry, a pointing device, such as a mouse, and so on. In general, inputs to system 950 can come from any of a variety of sources, machine generated and/or human generated.

Chipset 960 can also interface with one or more communication interfaces 990 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 955 analyzing data stored in storage 970 or 975. Further, the machine can receive inputs from a user via user interface components 985 and execute appropriate functions, such as browsing functions by interpreting these inputs using processor 955.

It can be appreciated that example systems 900 and 950 can have more than one processor 910 or be part of a group or cluster of computing devices networked together to provide greater processing capability.

For clarity of explanation, in some instances the present technology may be presented as including individual functional blocks including functional blocks including devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware, and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
receiving a first search string, at an online synchronized content management system, that identifies one or more content items in a first user account and in response to receiving the first search string, the online synchronized content management system automatically creates a collection of content items for association with a folder within a first user account, wherein the first user account is in the online synchronized content management system;
receiving an identification of content items identified by the first search string to exclude from the collection of content items; and
storing a content storage location to each of the one or more content items identified by the first search string, other than the excluded content items, and associated with the collection of content items, in the first user account in a shared folder, the shared folder synchronized with the first user account and a second user account allowing the first user account and the second user account to access the one or more content items in the first user account.

2. The computer-implemented method of claim 1, further comprising:
identifying one or more content items in the second user account according to a second search string, the second user account being in the online synchronized content management system; and
storing a content storage location to each of the one or more content items identified by the second search string in the second user account in the shared folder, the shared folder allowing the first user account or the second user account to access the one or more content items in the second user account.

3. The computer-implemented method of claim 1, further comprising:
identifying a content item accessible through a content storage location stored in the shared folder, the content item failing to satisfy the first search string or the second search string; and
removing the content storage location from the shared folder, whereby
when the content item originated in the first user account, removing the content storage location removes access to the content item by the second user account, and
when the content item originated in the second user account, removing the content storage location removes access to the content item by the first user account.

4. The computer-implemented method of claim 2, wherein the identifying one or more content items in the first user account according to the first search string includes identifying metadata of the one or more content items in the first user account that corresponds with the first search string.

5. The computer-implemented method of claim 4, wherein the identifying one or more content items in the second user account according to the second search string includes identifying metadata of the one or more content items in the second user account that corresponds with the second search string.

6. The computer-implemented method of claim 2 further comprising:
receiving a modification to a content item accessible through a content storage location stored in the shared folder, the modification received from the first user account or the second user account; and
providing access to the modification to the first user account and the second user account.

7. The computer-implemented method of claim 5, wherein metadata of a content item includes the content item's history and the history includes a user that has edited the content item.

8. (canceled)

9. The computer-implemented method of claim 2, wherein the first search string and the second search string include the same search criteria.

10. A system comprising:
a processor;
a computer readable medium; and
computer readable instructions, stored on the computer readable medium, that when executed by the processor are effective to cause the system to:
receive a first search string at an online synchronized content management system that identifies a first content item in a first user account and in response to receiving the first search string, the online synchronized content management system automatically creates a shared folder within a first user account and sets permissions for access to the first content item in accordance with the first search string, wherein the first user account is in an online synchronized content management system;
identify a second content item in a second user account according to a second search string whereby permissions for access to the second content item are set in accordance with the second search string, the second user account being in the online synchronized content management system; and
store, in the shared folder in the first user account, a first content storage location to the first content item identified by the first search string in the first user account and a second content storage location to the second content item identified by the second search string in the second user account, the shared folder allowing the first user account or the second user account to access the first content item in the first user account and the second content item in the second user account in accordance with the access permissions set for the first and second content items, wherein the shared folder is automatically synchronized with the first user account and the second user account.

11. The system of claim 10, wherein the instructions that cause the system to identify a first content item in the first user account further cause the system to identify metadata of the first content item in the first user account that corresponds with the first search string.

12. The system of claim 11, wherein the instructions that cause the system to identify a second content item in the second user account further cause the system to identify metadata of the second content item in the second user account that corresponds with the second search string.

13. The system of claim 10 wherein the instructions cause the system to further:
receive a modification to a content item accessible through a content storage location stored in the shared folder, the modification received from the first user account or the second user account; and
provide access to the modification to the first user account and the second user account.

14. The system of claim 13, wherein the modification is at least one of an edit to content in the content item, a change to the content item's name, or a change in the content item's storage location.

15. The system of claim 12, wherein metadata includes at least one of: content item creation location, content item name, content item storage location, content item type, content item history information and the history information includes a user that has edited the content item.

16. The system of claim 10, wherein the instructions cause the system to further:
detect a move of a content item accessible through a content storage location stored in the shared folder; and
update the content storage location in the shared folder to reflect the move.

17. A non-transitory computer-readable medium storing computer executable instructions for causing a computing device to:
receive a first search string at an online synchronized content management system that identifies one or more content items in a first user account and in response to receiving the first search string the online synchronized content management system automatically creates a shared folder within a first user account and sets permissions for access to the first content item in accordance with the first search string, wherein the first user account is in the online synchronized content management system;
identify a second content item in a second user account according to a second search string whereby permissions for access to the second content item are set in accordance with the second search string, the second user account being in the online synchronized content management system; and
store, in the shared folder, a first storage location to the first content item identified by the first search string in the first user account and a second storage location to the second content item identified by the second search string in the second user account, the shared folder synchronized with the first user account and the second user account allowing the first user account or the second user account to access the first content item in the first user account and the second content item in the second user account in accordance with the access permissions set for the first and second content items.

18. The non-transitory computer-readable medium of claim 17, wherein the instructions that cause the computing device to identify the first content item in the first user account further cause the computing device to identify metadata of the first content item in the first user account that corresponds with the first search string.

19. The non-transitory computer-readable medium of claim 18, wherein the instructions that cause the computing device to identify the second content item in the second user account further cause the computing device to identify metadata of the second content item in the second user account that corresponds with the second search string.

20. The non-transitory computer-readable medium of claim 17, wherein the instructions further cause the computing device to edit the content item in the shared folder in response to a request received from the first user account or the second user account.

21. The non-transitory computer-readable medium of claim 19, wherein metadata of a content item includes the content item's history and the history includes a user that has edited the content item.

22. The non-transitory computer-readable medium of claim 17, wherein the instructions further cause the computing device to:
in response to a request to view the shared folder, cause the one or more content items accessible through content storage locations stored in the shared folder to be presented as if the content items are stored in the shared folder.

23. The computer-implemented method of claim 1, wherein the online synchronized content management system automatically creates and automatically shares the shared folder with the second user account without user intervention.
